(19) United States
(12) Patent Application Publication
(10) Pub. No.: US 2026/0279714 A1
(43) Pub. Date: Sep. 17, 2026

(54) X-RAY APPARATUS WITH NON-LINEAR ANODE AND NON-LINEAR COOLING CHANNELS

(71) Applicant: VAREX IMAGING CORPORATION, Salt Lake City, UT (US)

(72) Inventors: Vance Scott Robinson, South Jordan, UT (US); Dave Kirkham, South Jordan, UT (US); Jake Riggle, Bountiful, UT (US); Kendra Jean Davis, Taylorsville, UT (US)

(73) Assignee: VAREX IMAGING CORPORATION, Salt Lake City, UT (US)

(21) Appl. No.: 19/554,874

(22) Filed: Mar. 3, 2026

Related U.S. Application Data
(60) Provisional application No. 63/772,183, filed on Mar. 14, 2025.

(51) Int. Cl. H01J 35/12

(52) U.S. Cl. CPC H01J 35/13

(57) ABSTRACT

Some embodiments include an x-ray apparatus, comprising: a non-linear anode; a non-linear cooling channel disposed within the non-linear anode; a target disposed on the non-linear anode; wherein: the target is configured to generate x-rays in response to incident electrons; and in a plane perpendicular to a path for coolant in the non-linear cooling channel, a material of the non-linear anode is continuous around the non-linear cooling channel.

### CROSS-REFERENCE TO RELATED APPLICATIONS

This application claims priority to U.S. Provisional Patent Application No. 63/772,183, filed 14 Mar. 2025, the entire disclosure of which is hereby incorporated by reference.

### FIELD

X-ray apparatuses include anodes with materials that generate x-rays in response to incident electrons. The incident electrons generate significant amounts of heat. The anode may include cooling passages for cooling media to remove the heat from the anode. Cooling passages within the anode may be formed by brazing two halves of the anode together. However, the size of the braze may be significant, increasing a difficulty of achieving a leak-free joint.

### BRIEF DESCRIPTION OF SEVERAL VIEWS OF THE DRAWINGS

FIGS. 1A-1B are block diagrams of a non-linear anode with non-linear cooling channels according to some embodiments.

FIGS. 2A-2D are block diagrams of a non-linear anode with non-linear cooling channels formed of linear cooling channels according to some embodiments.

FIGS. 3A-3C are block diagrams of examples of openings into non-linear cooling channels of a non-linear anode according to some embodiments.

FIG. 4 is a flowchart of a technique of forming a non-linear anode with non-linear cooling channels according to some embodiments.

FIGS. 5A-5B are block diagrams of tubing for non-linear cooling channels of a non-linear anode according to some embodiments.

FIGS. 6A-6C are block diagrams illustrating a technique of forming non-linear cooling channels of a non-linear anode with linear cooling channels according to some embodiments.

FIGS. 7A-7F are block diagrams of tubing disposed in a groove of a non-linear anode forming non-linear cooling channels according to some embodiments.

FIG. 8 is a block diagram of an x-ray imaging system according to some embodiments.

### DETAILED DESCRIPTION

Embodiments described herein relate to x-ray apparatus with non-linear anode and non-linear cooling channels. Some embodiments include distributed source x-ray apparatus including multiple cathodes emitting energy to targets on multiple anodes in an array. In order to manage the generated heat, the anode(s) may be cooled, such as by running a coolant behind the target. The heat may be significant due to the power and/or duty cycle of the x-ray apparatus. Such arrays may be arranged in a non-linear configuration, such as a curvilinear configuration. Non-linear configurations may create challenges in manufacturing a cooling channel within the anode.

When a non-linear anode is used cooling passages formed with long, straight holes may be difficult or impossible due to the curvature of the non-linear anode. Embodiments described herein include apparatuses and techniques of forming apparatuses that allow for non-linear cooling passages in non-linear anodes.

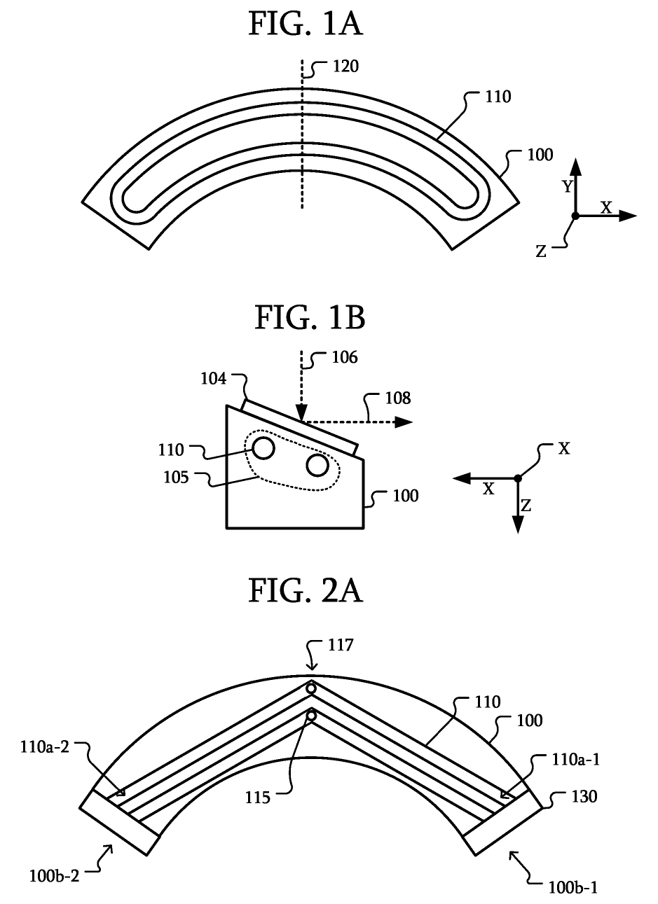

FIGS. 1A-1B are block diagrams of a non-linear anode with non-linear cooling channels according to some embodiments. Referring to FIGS. 1A-1B, in some embodiments, an x-ray apparatus 1 includes a non-linear anode 100 with a non-linear cooling channel 110 disposed within the non-linear anode 100. FIG. 1B is a cross-section along plane 120. The Y-Z plane is used as an example.

A target 104 is disposed on the non-linear anode 100. The target 104 is configured to generate x-rays 108 in response to incident electrons 106. The target 104 may include materials such as tungsten (W), molybdenum (Mo), rhodium (Rh), silver (Ag), rhenium (Re), palladium (Pd), alloys of such materials, or the like.

The non-linear anode 100 has a structure such that in a plane 120 perpendicular to a path for coolant in the non-linear cooling channel 110 (in the X-direction in this example), a material of the non-linear anode 100 is continuous around the non-linear cooling channel 110. Path 105 illustrates an example of the structure of the non-linear anode 100 in plane 120 that is continuous around the non-linear cooling channel 110.

The material of the non-linear anode 100 may not be continuous around the non-linear cooling channel 110 for every plane including the non-linear anode 100 and the non-linear cooling channel 110. However, in some embodiments in at least one plane, such as plane 120, the material of the non-linear anode 100 is continuous around the non-linear cooling channel 110 in all planes except for planes that intersect external connections through the non-linear anode 100 to the non-linear cooling channel 110. A variety of different structures of the non-linear anode 100 and non-linear cooling channel 110 will be described in detail below.

As used herein, for the non-linear anode 100 and the non-linear cooling channel 110, non-linear may include curved shapes, piecewise linear shapes, or other shapes that are not linear.

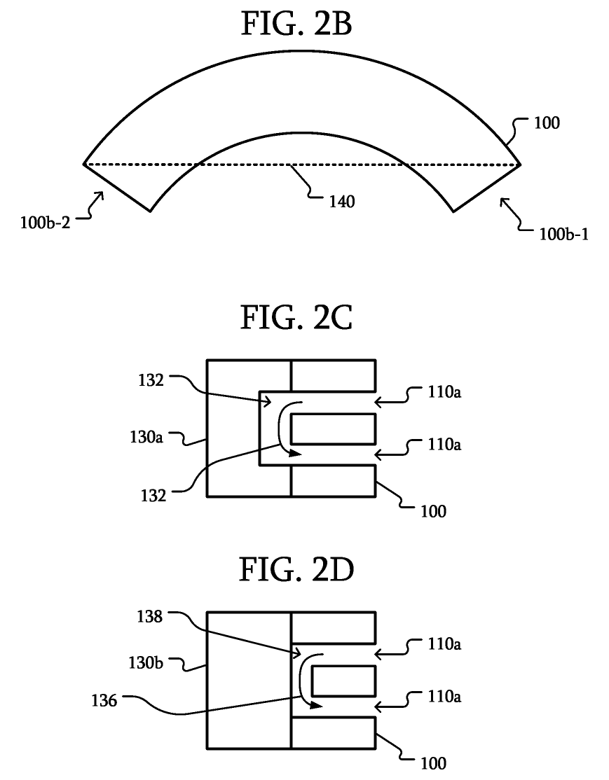

FIGS. 2A-2D are block diagrams of a non-linear anode with non-linear cooling channels formed of linear cooling channels according to some embodiments. Referring to FIG. 2A, in some embodiments, the non-linear cooling channel 110 is formed of multiple linear cooling channels 110a. The linear cooling channels 110a are coupled for cooling media flow. At least two of the linear cooling channels 110a are coupled for cooling media flow within the material of the non-linear anode 100. For example, linear cooling channels 110a-1 and linear cooling channels 110a-2 are coupled at location 117 within the non-linear anode 100.

Referring to FIGS. 2A and 2B, in some embodiments, the non-linear anode 100 may have the shape of an arc. The arc may extend between distal ends 100b-1 and 110b-2. Every line between distal ends 100b-1 and 100b-2 of the non-linear anode 100 extends outside of the non-linear anode 100. In this example, line 140 is the line between the ends 100b-1 and 100b-2 of the non-linear anode 100 extends outside of the non-linear anode 100. No line extends between the ends 100b-1 and 110b-2 entirely within the non-linear anode 100.

As a result, a linear cooling channel 110a cannot extend between the ends 100b-1 and 100b-2. That is, no straight linear cooling channel 110a may extend from one end 100b-1 to the other end 110b-2. At least two of the linear cooling channels 110a can be coupled so that the non-linear cooling channel 110 may extend between the ends 100b-1 and 100b-2. Here, two linear cooling channels 110a form a non-linear cooling channel 110; however, in other embodiments, more than two linear cooling channels 110a may be coupled to form a non-linear cooling channel 110. When the linear cooling channels 110a are coupled together, the non-linear cooling channel 110 may extend from one end 110b-1 to the other end 110b-2 even if no linear cooling channel 110a could reach from one end 110b-1 to the other end 110b-2.

In some embodiments, openings 115 are formed that extend into the non-linear cooling channel 110. In this example, each of the openings 115 extends into the non-linear cooling channel 110 where two corresponding linear cooling channels 110a are coupled. The openings 115 may be used as entry and exit points for cooling media. While the openings 115 are illustrated in particular positions, the openings may be disposed in different locations. While two openings 115 are used as an example, in other embodiments, more openings 115 may be disposed along the non-linear cooling channel 110 to allow for movement of cooling media in and out of the non-linear anode 100.

Referring to FIG. 2A and 2C, in some embodiments, at least one cap 130 is disposed at an end 100b of the non-linear anode 100. The cap 130 is configured to at least in part direct the cooling media flow from one linear cooling channel 110a to another. Here, the cap 130a is an example of a cap 130. The cap 130a includes a depression 134. The depression 134 couples the linear cooling channels 110a for cooling media flow. For example, cooling media may flow in the direction of arrow 132 from one linear cooling channel 110a through the depression 134 and into another linear cooling channel 110a.

Referring to FIG. 2A and 2D, in some embodiments, the cap 130b is an example of the cap 130. The cap 130b may not have a depression 134 similar to cap 130a. However, the non-linear anode 100 may include a depression 138 coupled with linear cooling channels 110a such that cooling media may flow as indicated by arrow 136. Although the cooling media does not flow through any portion of the cap 130b, the cap 130b still redirects the flow of the cooling media.

Although caps 130a and 130b have been used as example, in other embodiments, the cap 130 and/or the combination of the cap 130 and the non-linear anode 100 may be different but still redirect the cooling media flow.

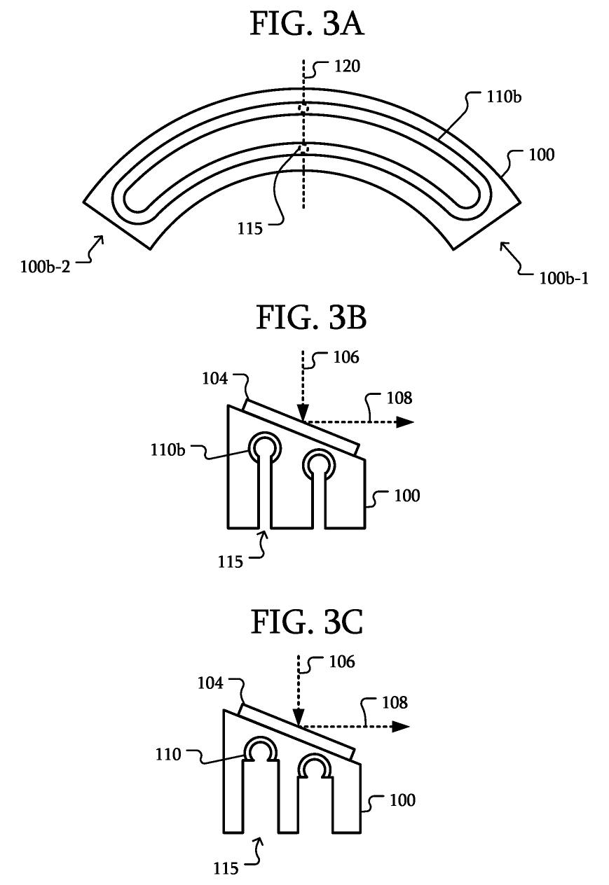

FIGS. 3A-3C are block diagrams of examples of openings into non-linear cooling channels of a non-linear anode according to some embodiments. Referring to FIG. 3A, in some embodiments, tubing 110b may be disposed within the non-linear anode 100. The tubing 110b may form the non-linear cooling channel 110. Openings 115 may be disposed with each opening extending through the non-linear anode 100 and a wall of the tubing 110b such that cooling media may enter and exit the tubing 110b.

The tubing 110b may be a closed path or an open path. The tubing 110b may have multiple branches, junctions, or the like within the non-linear anode 100. For example, at or near an opening 115, the tubing 110b may branch into three or more paths extending away from the opening further into the non-linear anode 100.

Although tubing 110b is illustrated in a single path, in other embodiments, the tubing 110b may be disposed in multiple separate paths within the non-linear anode 100. For example, tubing 110b may be disposed in multiple closed paths within the non-linear anode 100, each with openings 115 to allow for coolant media flow.

Referring to FIGS. 3A and 3B, FIG. 3B is a cross-section along plane 120 of the non-linear anode 100 of FIG. 3B similar to that of FIG. 1B, including similar elements. In some embodiments, each of the openings 115 has a dimension smaller than a diameter of the tubing. The diameter may be an inner diameter or an outer diameter of the tubing 110b.

With a smaller dimension of the opening 115, material of the tubing 110b may be exposed. Other tubing or structures may be attached to the tubing 110b to create a hermetic seal. The hermetic seal for the cooling media may allow for a material that would not create a hermetic seal to be used for the non-linear anode 100.

Referring to FIGS. 3A and 3C, FIG. 3C is another example of a cross-section along plane 120 of the non-linear anode 100 of FIG. 3A, similar to that of FIG. 3B. In some embodiments, each of the openings 115 has a dimension 144 larger than an outer diameter 146 of the tubing 110b.

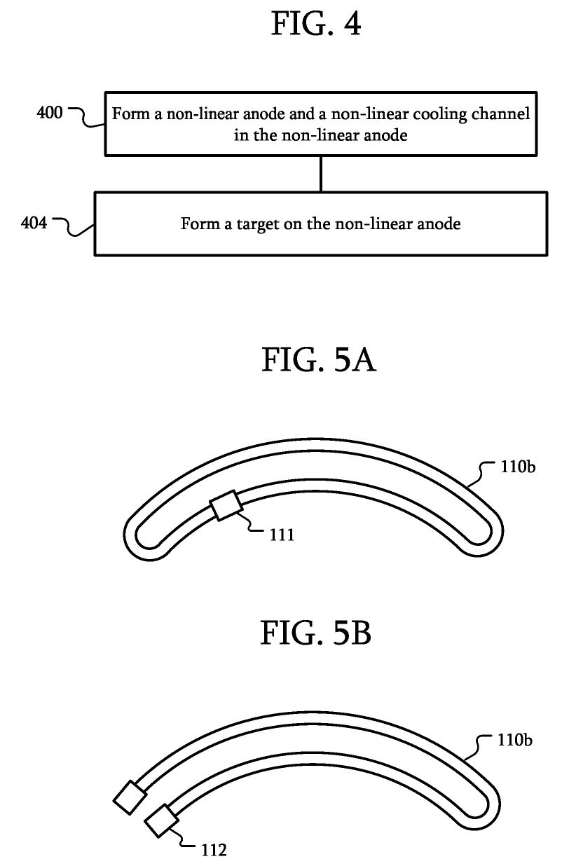

FIG. 4 is a flowchart of a technique of forming a non-linear anode with non-linear cooling channels according to some embodiments. Referring to FIGS. 1A, 1B, and 4, in some embodiments, in 400, a non-linear anode 100 and a non-linear cooling channel 110 in the non-linear anode 100 are formed. In 404, a target 104 is formed on the non-linear anode 100.

Forming the non-linear anode 100 and non-linear cooling channel 110 may be performed in a variety of ways and in a variety of sequences as will be described in further detail below. In some embodiments, the non-linear cooling channel 110 is formed before forming the non-linear anode 100 and in other embodiments, the non-linear cooling channel 110 is formed after forming the non-linear anode 100. In some embodiments, the non-linear anode 100 and the non-linear cooling channel 110 are formed at the same time.

FIGS. 5A-5B are block diagrams of tubing for non-linear cooling channels of a non-linear anode according to some embodiments. Referring to FIG. 5A, in some embodiments, the non-linear cooling channel 110 is formed by bending tubing 110b to form the non-linear cooling channel 110. The tubing 110b may be bent into the desired shape. In this example, the tubing 110b is bent into a continuous loop. The bent tubing 110b may be sealed with a coupler 111, brazed, welded, or the like to create a sealed non-linear cooling channel 110.

The tubing 110b may include a variety of materials. For example, the tubing 110b may include copper, stainless steel, titanium, Kovar, or the like. The material of the non-linear anode 100 may be selected to have a lower melting point than the tubing 110b. The tubing 110b material and the material of the non-linear anode 100 may be selected to allow for optimization of material proprieties to achieve better cooling, conduction, control of thermal expansion, or the like.

Referring to FIG. 5B, in some embodiments, the non-linear cooling channel 110 is again formed by bending tubing 110b to form the non-linear cooling channel 110. However, the tubing 110b is bent into a non-continuous path. The ends of the tubing may be sealed with a cap 112, crimped, brazed, welded, or the like to seal the tubing 110b to form the non-linear cooling channel 110.

Referring to FIGS. 1A, 5A, and 5B, in some embodiments, forming the non-linear anode 100 and forming the non-linear cooling channel 110 includes forming tubing 110b into the non-linear cooling channel 110 and forming anode material around the tubing to form the non-linear anode.

In some embodiments, once the tubing 110b is formed into a desired shape, the non-linear anode 100 may be formed by additive manufacturing processes. Examples of additive manufacturing processes include casting, sintering, or the like. The additive manufacturing may form the non-linear anode 100 into the desired shape. For example, after forming the non-linear anode 100 around the tubing 110b, the non-linear anode 100 may have roughly the desired shape, but the surface may be not within desired tolerances, may not have a desired finish, or the like. The non-linear anode 100 may then be machined to a desired shape, polished, or the like to create a desired final shape and finish.

This process may result in less wasted material as compared to a technique where a cooling channel is machined or cut out. In addition, the effort and labor to form and pinch tubing 110b may be less than that used to machine a cooling channel.

As part of or after the machining of the non-linear anode 100, openings 115 such as those described above may be formed in the non-linear anode 100 extending to the tubing 110b. Tubing for external connections may then be attached through the openings 115 to the tubing 110b, walls of the openings 115, or the like to allow access to the non-linear cooling channel 110. In some embodiments, hermetic seals may be formed to the tubing 110b through each of the openings 115.

In some embodiments, the target 104 may be attached at the same time as the non-linear anode 100 is being formed. For example, the non-linear anode 100 may be cast around the target 104. The tubing 110b may be present so that the non-linear anode 100 is cast around the tubing 110b when casting the non-linear anode 100 around the target 104.

In some embodiments, after forming the non-linear anode 100 around the tubing 110b, portions of the tubing 110b may extend out of the non-linear anode 100 after the additive manufacturing process. The tubing 110b may have been sealed before the additive manufacturing process; however, the tubing 110b may be cut to allow access to the non-linear cooling channel 110.

In some embodiments, the tubing 110b may be sealed before the additive manufacturing process. For example, metal laser sintering may involve loose powder. The sealed tubing 110b may keep the material out of the non-linear cooling channel 110. However, in other embodiments, the tubing 110b may be flushed after forming the non-linear anode 100.

Referring back to FIG. 1A and 1B, in some embodiments, the non-linear anode 100 and the non-linear cooling channel 110 may be formed at the same time by the same process. As a result, walls of the non-linear cooling channel 110 are formed by the non-linear anode 100 itself.

In some embodiments, the non-linear anode 100 may be 3D metal printed in a manner such that the printing process leaves the non-linear cooling channels 110. 3D metal printing techniques include direct laser sintering (DLS), laser weldable material, direct metal printing (DMP), or the like.

The non-linear cooling channel 110 formed in this manner may include shapes other than joined linear segments such as the linear cooling channels 110a or bent tubular structures such as the shaped tubing 110b. Rather, with 3D metal printing, non-linear cooling channel 110 may be formed with a desired shape, structure or the like. For example, a 3D printed non-linear cooling channel 110 may include three dimensionally changing non-linear cooling channel 110 such as a helix within the non-linear anode 100. In another example, a 3D printed non-linear cooling channel 110 may include internal structures extending from the non-linear anode 100 into the non-linear cooling channel 110 such as protrusions, bumps, fins, or other structures configured to improve heat exchange from a target 104 side of the non-linear anode 100 and the cooling media.

In some embodiments, the 3D metal printing is not constrained by the same axes of other machining techniques. As a result, the cooling features of the non-linear cooling channel 110 can be formed with curved or multi-axis geometries. In addition, interwoven shapes such as a double helix may be printed.

In some embodiments, multiple non-linear anodes 100 may be 3D printed. The individual non-linear anode 100 may be attached together through techniques such as welding, brazing, or the like.

In some embodiments, 3D printing the non-linear anode 100 may allow for otherwise unavailable structures. For example, a cross-section of a non-linear cooling channel 110 may be changed along a length of the non-linear cooling channel 110. A width, volume, or the like of the non-linear cooling channel 110 near a feature, such as a potential focal spot, may have a larger portion of the non-linear cooling channel 110 or a reservoir. Further from the focal spot, the non-linear cooling channel 110 may decrease in width, volume, or the like.

Materials from the 3D printing process may become suspended in cooling media flowing through the non-linear cooling channels 110. The suspended material may change conductive paths through the non-linear cooling channels 110 and may lead to arcing. In some embodiments, an x-ray apparatus with a 3D printed non-linear anode 100 may include a coolant filter. The coolant filter may be configured to filter out remaining materials from the 3D printing process.

Some manufacturing practices include casting or milling of raw materials followed by significant machining or subtractive manufacturing. This approach may generate significant waste material. In addition, subsequent metal joining techniques may be used to arrive at desired geometries. The limits of subtractive manufacturing may be the drivers of many design elements and constraints considered in order to arrive at a desired outcome. In addition, some structures simply cannot be manufactured through traditional practices.

In some embodiments, the use of additive manufacturing may reduce or eliminate waste by generating near net shapes that include minimal machining. In addition, additive manufacturing may reduce weight through the use of printing patterns such as internal lattice structures rather than solid internal structures. Elimination of subsequent metal joining can be achieved by printing the areas that would otherwise include additional metal joining.

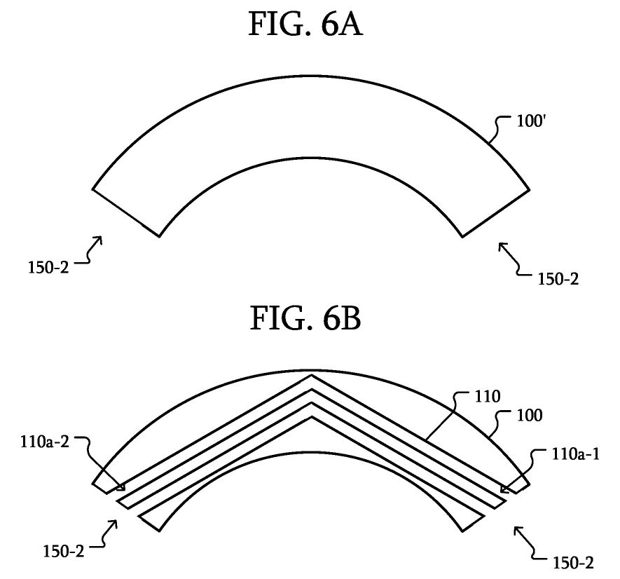

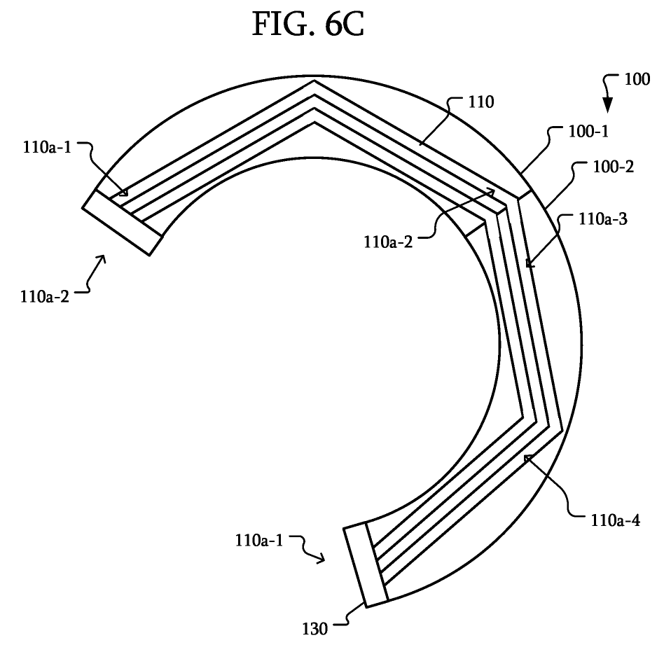

FIGS. 6A-6C are block diagrams illustrating a technique of forming non-linear cooling channels of a non-linear anode with linear cooling channels according to some embodiments. Referring to FIGS. 4, 6A, and 6B, in some embodiments, the non-linear anode 100 and non-linear cooling channel 110 are formed by forming linear cooling channels 110a. Material for the anode may be formed into a non-linear anode block 100’. A non-linear anode block 100’ without cooling channels may be provided as illustrated in FIG. 6A. The non-linear anode block 100’ comprising the material of the non-linear anode 100 may be formed by a variety of processes such as casting, machining, or the like.

The non-linear anode 100 block may be drilled from each end 150-1 and 150-2. The drilling may be blind drilling where the drill does not exit the non-linear anode block 100’. The resulting opening in the non-linear anode 100 is a linear cooling channel 110a. Each linear cooling channel 110a may extend far enough into the non-linear anode 100 to connect with another of the linear cooling channels 110a. The non-linear anode 100 may then be sealed by one or more caps 130 as illustrated in FIG. 2A. The sealing with the one or more caps 130 may form at least part of the non-linear cooling channel 110 as described above.

In some embodiments, openings 115 such as those in FIG. 2A are formed. The openings 115 may be formed by drilling from an exterior of the non-linear anode 100 into one or more of the linear cooling channels 110a.

Referring to FIG. 6C, in some embodiments, multiple non-linear anodes such as non-linear anode 100-1 and 100-2 may be joined to form the non-linear anode 100. For example, the non-linear anode 100-1 and 100-2 may be joined by brazing, welding, or the like. As part of the joining process, the linear cooling channels 110a may be coupled for coolant media flow.

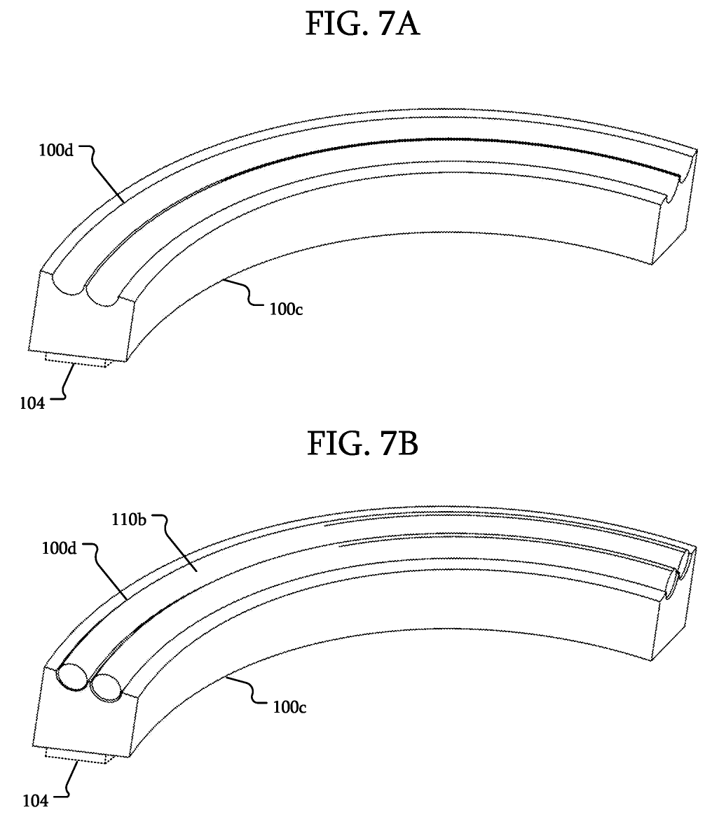

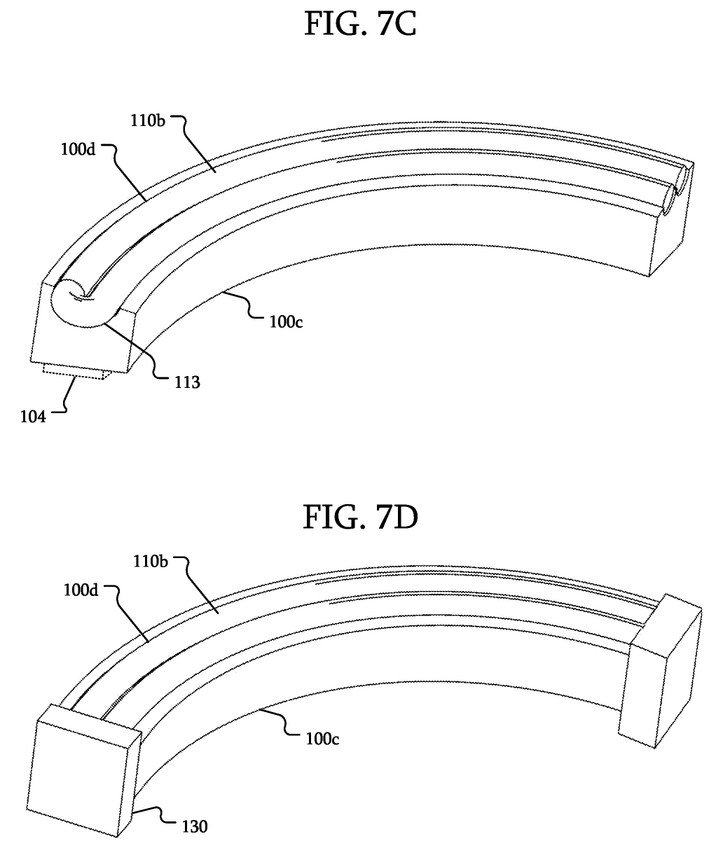

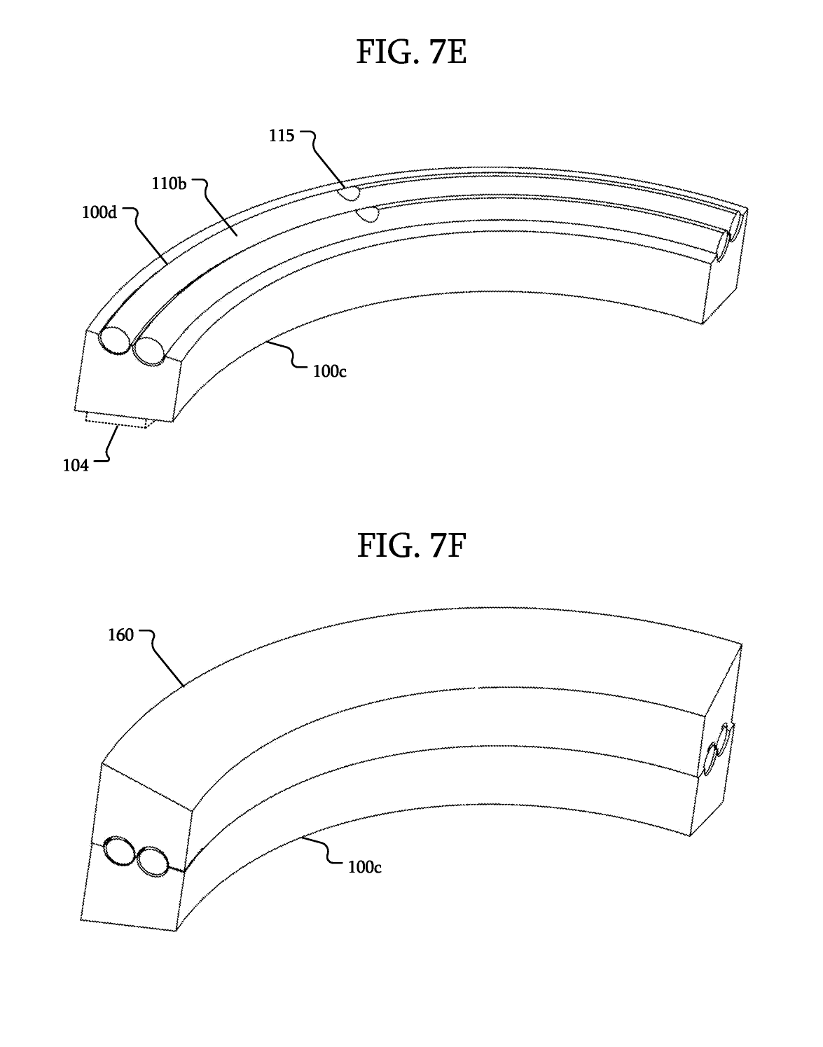

FIGS. 7A-7B are block diagrams of tubing disposed in a groove of a non-linear anode forming non-linear cooling channels according to some embodiments. Referring to FIG. 7A, in some embodiments, a non-linear anode base 100c may be formed with non-linear grooves 110d on an opposite side of the non-linear anode base 100c from a target 104. The target 104 may or may not be disposed on the non-linear anode base 100c at this time, but if not, the target 104 may be attached later.

Referring to FIG. 7B, tubing 110b may be placed in the non-linear grooves 110d on the non-linear anode base 100c to form the non-linear anode 100. As a result, the tubing 110b may form non-linear cooling channels 110. The tubing 110b may be attached to the non-linear anode base 100c through a variety of ways, such as welding, brazing, or the like.

Referring to FIG. 7C, in some embodiments, the tubing 110b may extend beyond the non-linear anode base 100c. The tubing 110b may extend beyond the non-linear anode base 100c at one or more ends of the non-linear anode base 100c. A portion of the tubing may form a return bend 113 at one or more ends of the non-linear anode base 100c. The return bend 113 may be part of the tubing 110b, a fitting attached to the tubing 110b, or the like.

Referring to FIG. 7D, in some embodiments, one or more caps 130 are disposed at corresponding ends of the non-linear anode 100. Each cap 130 may be configured to redirect at least in part cooling media flow through the tubing 110b similar to the caps 130 described above.

Referring to FIG. 7E, in some embodiments, openings 115 may be formed in the tubing 110b. The openings 115 may be formed similar to openings 115 described above, in similar numbers and locations.

Referring to FIG. 7F, in some embodiments, a cover 160 is disposed over the tubing 110b on the non-linear anode 100. The cover 160 may have a mirror image structure as the non-linear anode base 100c to mate with the tubing 110b; however, in other embodiments, the cover 160 may have a different shape. In some embodiments, the cover 160 may include radiating structures, such as fins to radiate heat.

In some embodiments, the cover 160 may include a material different from the non-linear anode base 100c. A different material may provide additional advantages. For example, the cover 160 may have a greater thermal capacity than the non-linear anode base 160c. In another example, the cover 160 may be a material with a stiffness greater than the non-linear anode base 160c.

While an arc that corresponds to the arc of the non-linear anode 100 has been used as an example of the non-linear groove 110d, the non-linear groove 110d may take other forms. For example, the non-linear groove 110d may follow a sinusoid, a square wave, a sawtooth, or other patterns along the non-linear anode base 100c. The tubing 110b may be formed similarly to be placed in the non-linear groove 110d.

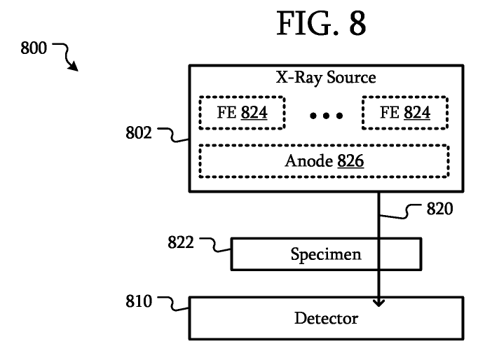

FIG. 8 is a block diagram of an x-ray imaging system according to some embodiments. The x-ray source 802 includes a non-linear anode 100 as described above as the anode 826. In some embodiments, the x-ray source 802 includes multiple field emitters (FE) 824. Electron beams from the field emitters 824 may be directed towards an anode 826 to generate x-rays 820. The x-ray source 802 is disposed relative to the detector 810 such that x-rays 820 may be generated to pass through a specimen 822 and detected by the detector 810. In some embodiments, the detector 810 is part of a medical imaging system. In other embodiments, the x-ray detector 800 may include a portable vehicle scanning system as part of a cargo scanning system. The x-ray detector 800 may be any system that may include an x-ray detector.

Although the structures, devices, methods, and systems have been described in accordance with particular embodiments, one of ordinary skill in the art will readily recognize that many variations to the particular embodiments are possible, and any variations should therefore be considered to be within the spirit and scope disclosed herein. Accordingly, many modifications may be made by one of ordinary skill in the art without departing from the spirit and scope of the appended claims.

The claims following this written disclosure are hereby expressly incorporated into the present written disclosure, with each claim standing on its own as a separate embodiment. This disclosure includes all permutations of the independent claims with their dependent claims. Moreover, additional embodiments capable of derivation from the independent and dependent claims that follow are also expressly incorporated into the present written description. These additional embodiments are determined by replacing the dependency of a given dependent claim with the phrase “any of the claims beginning with claim [x] and ending with the claim that immediately precedes this one,” where the bracketed term “[x]” is replaced with the number of the most recently recited independent claim. For example, for the first claim set that begins with independent FIG. 1, FIG. 4 can depend from either of FIGS. 1 and 3, with these separate dependencies yielding two distinct embodiments; FIG. 5 can depend from any one of FIGS. 1, 3, or 4 with these separate dependencies yielding three distinct embodiments; claim 6 can depend from any one of FIGS. 1, 3, 4, or 5, with these separate dependencies yielding four distinct embodiments; and so on.

Recitation in the claims of the term “first” with respect to a feature or element does not necessarily imply the existence of a second or additional such feature or element.

1. An x-ray apparatus comprising:
a non-linear anode;
a non-linear cooling channel disposed within the non-linear anode;
a target disposed on the non-linear anode;
wherein:
the target is configured to generate x-rays in response to incident electrons; and
in a plane perpendicular to a path for coolant in the non-linear cooling channel, a material of the non-linear anode is continuous around the non-linear cooling channel.

2. The x-ray apparatus of claim 1, wherein:
the non-linear cooling channel comprises a plurality of linear cooling channels coupled for cooling media flow; and
at least two of the linear cooling channels are coupled for the cooling media flow within the material of the non-linear anode.

3. The x-ray apparatus of claim 2, further comprising a cap disposed at an end of the non-linear anode, wherein the cap is configured to direct the cooling media flow from one of the linear cooling channels to another of the linear cooling channels.

4. The x-ray apparatus of claim 1, wherein the non-linear cooling channel comprises tubing disposed within the non-linear anode.

5. The x-ray apparatus of claim 4, further comprising a plurality of openings, each of the openings extending through the non-linear anode and a wall of the tubing.

6. The x-ray apparatus of claim 5, wherein each of the openings has a dimension smaller than a diameter of the tubing.

7. The x-ray apparatus of claim 1, wherein walls of the non-linear cooling channel are formed by the non-linear anode.

8. A method comprising:
forming a non-linear anode;
forming a non-linear cooling channel in the non-linear anode; and
forming a target on the non-linear anode;
wherein:
the target is configured to generate x-rays in response to incident electrons.

9. The method of claim 8, wherein forming the non-linear anode and forming the non-linear cooling channel comprises:
forming tubing into the non-linear cooling channel; and
forming anode material around the tubing to form the non-linear anode.

10. The method of claim 9, further comprising sealing the tubing before forming the anode material around the tubing.

11. The method of claim 9, further comprising forming a plurality of openings, each of the openings extending through the non-linear anode and a wall of the tubing.

12. The method of claim 11, further comprising forming hermetic seals to the tubing through each of the openings.

13. The method of claim 8, wherein forming the non-linear anode and forming the non-linear cooling channel comprises:
forming anode material into the non-linear anode; and
forming a plurality of linear cooling channels coupled for cooling media flow in the non-linear anode to form at least part of the non-linear cooling channel.

14. The method of claim 13, further comprising capping an end of the non-linear anode, wherein capping the end of the non-linear anode forms at least another part of the non-linear cooling channel to direct the cooling media flow from one of the linear cooling channels to another of the linear cooling channels.

15. The method of claim 13, further comprising forming a plurality of openings through the non-linear anode, each of the openings extending into one of the linear cooling channels.

16. The method of claim 13, wherein forming the linear cooling channels comprises blind drilling from multiple ends of the non-linear anode to form the linear cooling channels.

17. The method of claim 8, wherein:
forming the non-linear anode and forming the non-linear cooling channel comprises forming anode material into the non-linear anode with openings within the non-linear anode; and
the openings form at least part of the non-linear cooling channel.

18. An x-ray apparatus comprising:
a non-linear anode comprising a non-linear groove;
tubing disposed in the non-linear groove;
a target disposed on the non-linear anode;
wherein:
the target is configured to generate x-rays in response to incident electrons; and
the target is disposed on a side of the non-linear anode opposite to the tubing.

19. The x-ray apparatus of claim 18, wherein the tubing comprises a return bend at an end of the non-linear anode.

20. The x-ray apparatus of claim 18, further comprising a cap disposed at an end of the non-linear anode, wherein the cap is configured to direct cooling media flowing through the tubing.
